(19) United States
(12) Patent Application Publication
(10) Pub. No.: US 2005/0057087 A1
(43) Pub. Date: Mar. 17, 2005

(54) Foot control system for a vehicle

(76) Inventor: Bruce Ahnafield, Indianapolis, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/903,180

(22) Filed: Jul. 30, 2004

Related U.S. Application Data
(60) Provisional application No. 60/491,759, filed on Aug. 1, 2003.

(51) Int. Cl. B60T 13/66

(52) U.S. Cl. 303/20

(57) ABSTRACT

A system for use by a physically impaired driver for controlling a vehicle includes an actuator assembly operably coupled to the accelerator and brake pedals of the vehicle. The actuator assemblies include electrical motors operable to depress the brake pedal and the accelerator pedal. A pair of foot controllers are provided that are separate from the existing vehicle pedals. The foot controllers can be manipulated by the driver to generate acceleration and braking commands which are fed to an on board processor. This processor provides appropriate motor control commands to the processor to produce a vehicle acceleration or braking indicative of the driver command.

### CROSS-REFERENCE TO RELATED APPLICATION

This application claims priority to co-pending provisional application No. 60/491,759, filed on Aug. 1, 2003, the disclosure of which is incorporated herein by reference.

### BACKGROUND OF THE INVENTION

The present invention relates to a system for controlling a motor vehicle, and particularly for operating the vehicle accelerator and brakes. This invention can be readily applied to vehicle control systems for physically impaired drivers.

A conventional motor vehicle, such as an automobile, is designed for a driver having full and substantially unrestricted use of all of their limbs. The standard vehicle controls include a rotary operating steering wheel, a depressible brake pedal, and a depressible accelerator pedal. Of course, it is known that the steering wheel is operated manually, while the brake and accelerator pedals are operated by the driver's feet. Current production vehicles assume that the driver has full use of his/her hands and feet in order to operate these vehicle controls.

Unfortunately, a significant percentage of the driving population does not have full use of all of their limbs. For instance, drivers with certain physical disabilities may be unable to use their legs to operate the brake and accelerator pedals. Although no production vehicles have been developed to account for physically-impaired drivers, a significant amount of effort has been expended in developing systems that can be integrated into an existing vehicle control system to accommodate this driving population. One such system is depicted and described in U.S. Pat. No. 4,722,416, which issued on Feb. 2, 1998 to one of the inventors of the present invention. A system embodying the teachings of the '416 patent has been sold by Ahnafield Corporation as its “Joystick Driving Control®” system. The basic components of this system are shown in FIG. 1. In particular, a vehicle V, which includes a steering wheel S, a brake pedal B, and an accelerator pedal A, is provided with a braking/acceleration control system 10 that integrates with the vehicle controls.

A joystick controller 12 is provided that can be manually manipulated by the physically-impaired driver. This joystick controller is linked to a control box 14 which carries an electronic circuit or microprocessor that produces control signals in response to movement of the joystick controller 12. These signals operate a brake control cylinder 16 or an accelerator control cylinder 18. These cylinders are part of a hydraulic system that can be actuated by signals from the control box 14 to depress or retract either of the two control pedals B, A. In certain applications, the joystick controller 12 can be a two-axis joystick, meaning that movement in one direction, say left or right, can be used to operate the steering in lieu of the steering wheel S, while movement in a perpendicular direction, such as forward and backwards, controls either the brake or accelerator pedal.

While the Joystick Driving Control® vehicle control system has been very successful in improving the freedom and mobility of the physically-impaired driver, there is always room for improvement. For instance, some drivers do have full use of their legs, but are unable to reach or lack the strength to operate the accelerator and brake pedals that come with most vehicles. Thus, there remains a need for a foot control system that augments a driver's own foot operation.

### SUMMARY OF THE INVENTION

To address this continuing need, the present invention provides a system for use by a physically impaired driver for controlling the braking and acceleration functions of a vehicle. In one embodiment, the system includes a pair of foot control units that can be operated by the driver to generate acceleration and braking signals These signals are processed by an on-board controller, such as a microprocessor, to generate control signals fed to an actuator mechanism. The actuator mechanism is coupled to the vehicle's accelerator and brake pedals and is operable to depress these pedals in response to the driver's commands.

In one embodiment of the invention, a system is provided for use by a physically impaired driver for controlling a pedal of a motor vehicle. The system comprises a foot pedal mounted within the vehicle offset from the pedal of the vehicle, wherein the foot pedal is movable by the driver's foot away from a neutral position corresponding to depressing the vehicle pedal. The foot pedal preferably includes a return mechanism for restoring the foot pedal to the neutral position. The system further comprises an actuator assembly operably coupled to the vehicle pedal to depress the vehicle pedal when activated and an electrical control system connected between the foot pedal and the actuator assembly. The control system is operable to activate the actuator to depress the vehicle pedal when the foot pedal is moved away from the neutral position.

In the preferred embodiment, the foot pedal is supported on a housing configured to elevate the foot pedal above the vehicle pedal. The housing can be mounted to the vehicle floor by screws or bolts and is sized so that the housing and foot pedal are accessible by the impaired drive but also clear of the existing vehicle pedals for use by an un-impaired driver. The foot pedal is pivotably mounted on the housing. A sensor is coupled to the foot pedal and is operable to generate a signal whose magnitude is a function of the amount of movement of the foot pedal away from the neutral position. In other words, the sensor generates a greater voltage as the foot pedal is depressed or pivoted away from the neutral position. An electrical controller receives the sensor signal and controls a motor for driving the actuator assembly in response to the magnitude of the signal.

In a further aspect of the invention, the electrical control system further includes a limit switch operably coupled to the foot pedal to generate a limit signal when the foot pedal has been moved to a limit position relative away from the neutral position. For instance, the limit switch can correspond to an emergency braking in which the foot pedal is fully depressed. With this feature, the electrical controller is operable to control the motor independent of the magnitude of the sensor signal when the limit signal is received by the controller. In the case of an emergency braking maneuver, the electrical controller automatically activates the motor to drive the brake actuator to its fullest extent.

In certain embodiments, the return mechanism includes a spring coupled between the housing and the foot pedal. The spring is preferably an extension spring operable to resist movement of the foot pedal away from the neutral position. Most preferably, the resistance of the extension spring is adjustable so that the movement of the foot pedal can be calibrated to the physical capabilities of the driver.

It is one object of the invention to provide a system that can be easily managed by a person having a physical disability that might otherwise prevent that person from operating a motor vehicle. One important object is to provide such a system that can provide that driver with the greatest ability to control the vehicle braking and acceleration.

A further object of the invention resides in features that make the system easy to retrofit to an existing vehicle, specifically with as little disruption to the driver-side area of the vehicle. Yet another object is accomplished by features that ensure stable and reliable actuation of the brake pedal, especially in an emergency braking condition.

These and other objects, as well as many benefits of the present invention, will become apparent upon consideration of the following written description, taken together with the accompanying figures.

### DESCRIPTION OF THE FIGURES

FIG. 1 is a perspective view of one type of prior art vehicle control system.

FIG. 2 is a front view of the dashboard of a vehicle with an actuator mechanism mounted thereto for use in connection with the foot control system of the present invention.

FIG. 3 is a top elevational view of an acceleration/braking assembly included in the foot control system of the present invention.

FIG. 4a is a top perspective view of the connection between the vehicle brake pedal and the braking components of the actuator mechanism shown in FIG. 2.

FIG. 4b is a top perspective view of an alternative connection between the vehicle brake pedal and the braking components of the actuator mechanism shown in FIG. 2.

FIG. 5 is a top perspective view of the connection between the vehicle accelerator pedal and the acceleration components of the actuator mechanism shown in FIG. 2.

FIG. 6 is an exploded view of the components of the foot control system according to one embodiment of the present invention.

FIG. 7 is a bottom view of the internal components of the foot control pedal of the system shown in FIG. 6.

### DESCRIPTION OF THE PREFFERED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

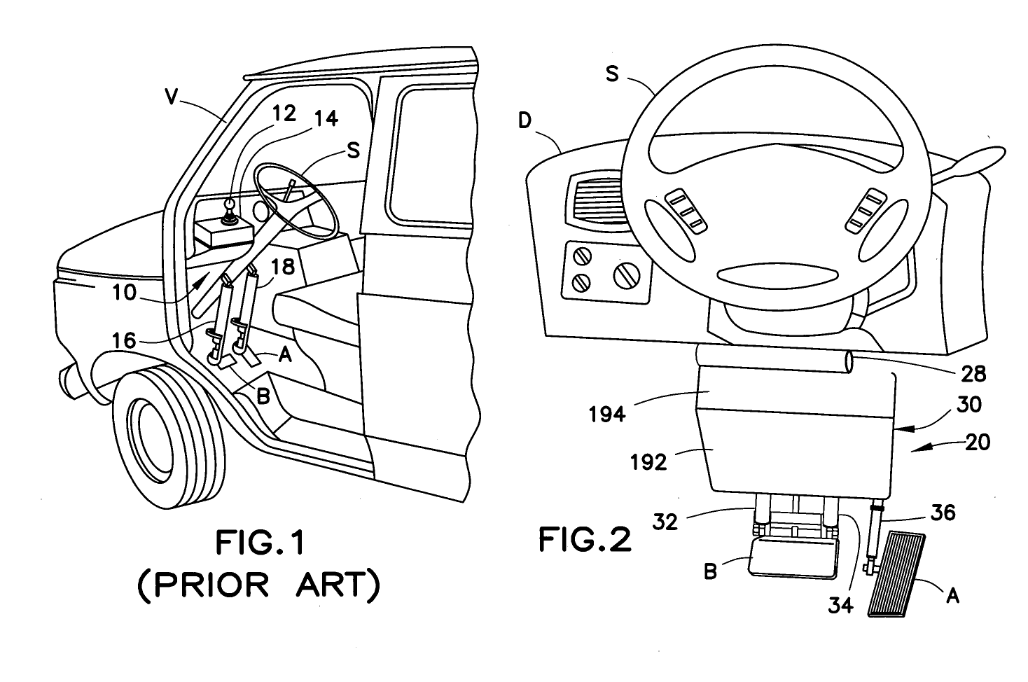

The present invention contemplates a vehicles control system for integration into an existing vehicle. In particular, the vehicle control system 20 of the present invention interfaces with the vehicle brake pedal B and accelerator pedal A, as shown in FIG. 2. Moreover, the control system 20 is supported relative to the column for the steering wheel S, and requires only minimal modification to the vehicle dashboard D. As is typical in the industry, the vehicle is preferably a van-type vehicle, such as the van V depicted in FIG. 1, since vehicles of this type more readily accommodate wheelchair-bound drivers. However, it is understood that the principles of the present invention can be implemented on vehicles of virtually any type, including sedans, with appropriate modification and adjustment of the relative dimensions of the system 20.

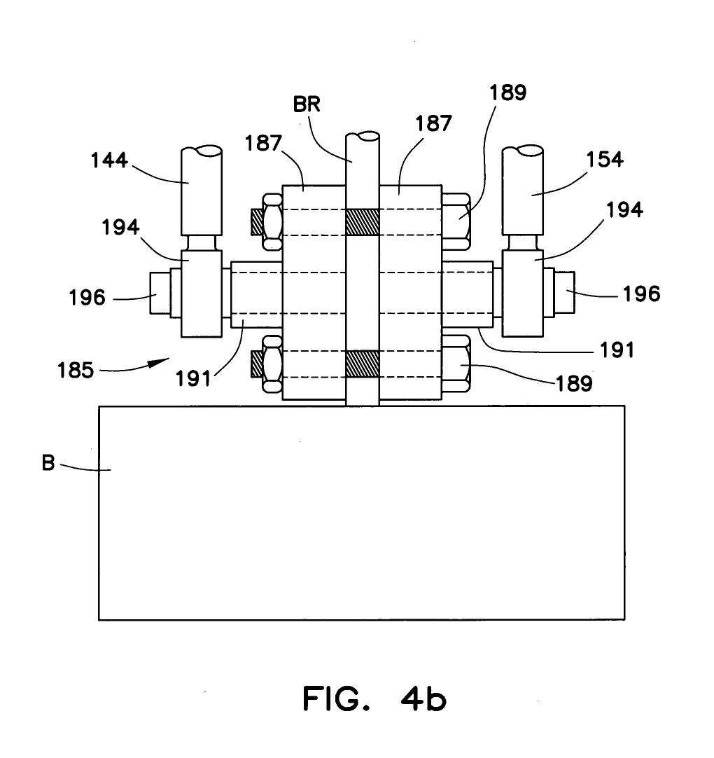

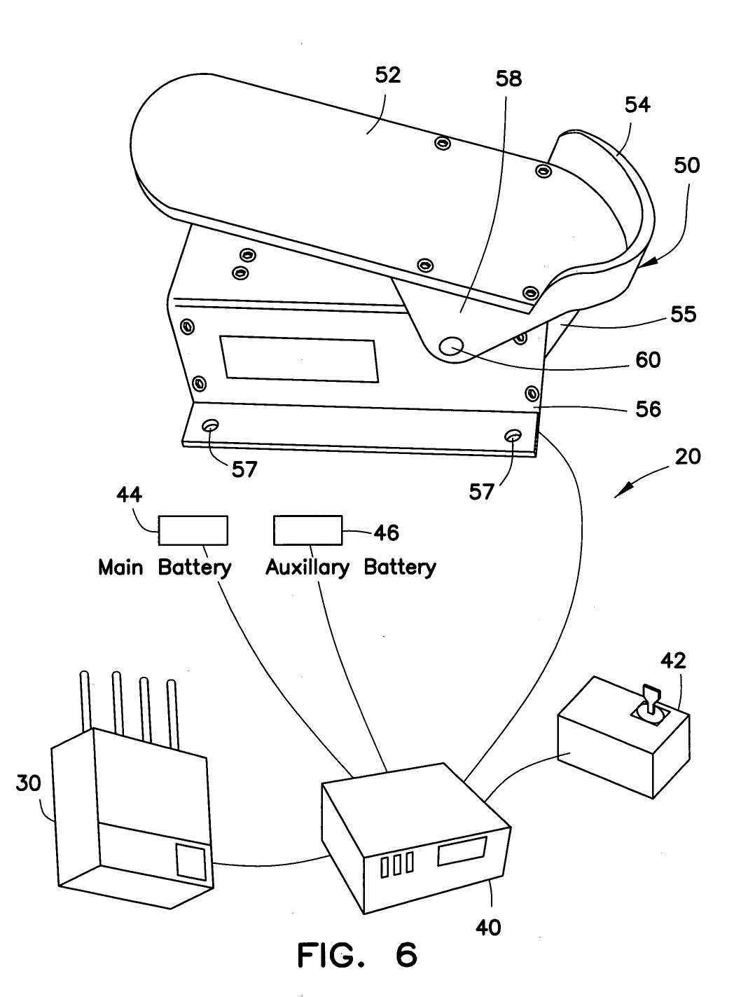

As shown in FIG. 6, the vehicle control system 20 includes an actuator mechanism 30 for controlling the actual accelerator and brake pedals of the vehicle, and an electronic controller or microprocessor 40 that generates commands to control the operation of the actuator mechanism. The microprocessor is also linked to an annunciator panel 42 that can include status lights to indicate the status of the system or alert to an error condition. The panel 42 can also include an activation key for starting up the vehicle control system 20 when the vehicle is started. Power is provided to the control system through the microprocessor 40. The existing vehicle battery 44 is the primary power source for the system, although an auxiliary battery 46 can be provided. A foot pedal controller 50 provides the avenue for operator input to control the vehicle acceleration and/or braking.

Returning to FIG. 2, it can be seen that the steering column mount supports an actuator mechanism 30 from which extends actuators for controlling the movement of the brake pedal B and the accelerator pedal A. In the preferred embodiment, the actuator mechanism 30 includes a primary brake actuator 32 and a secondary brake actuator 34 that integrates with the brake pedal. In addition, the actuator mechanism 30 includes an accelerator actuator 36 that connects to the vehicle accelerator pedal.

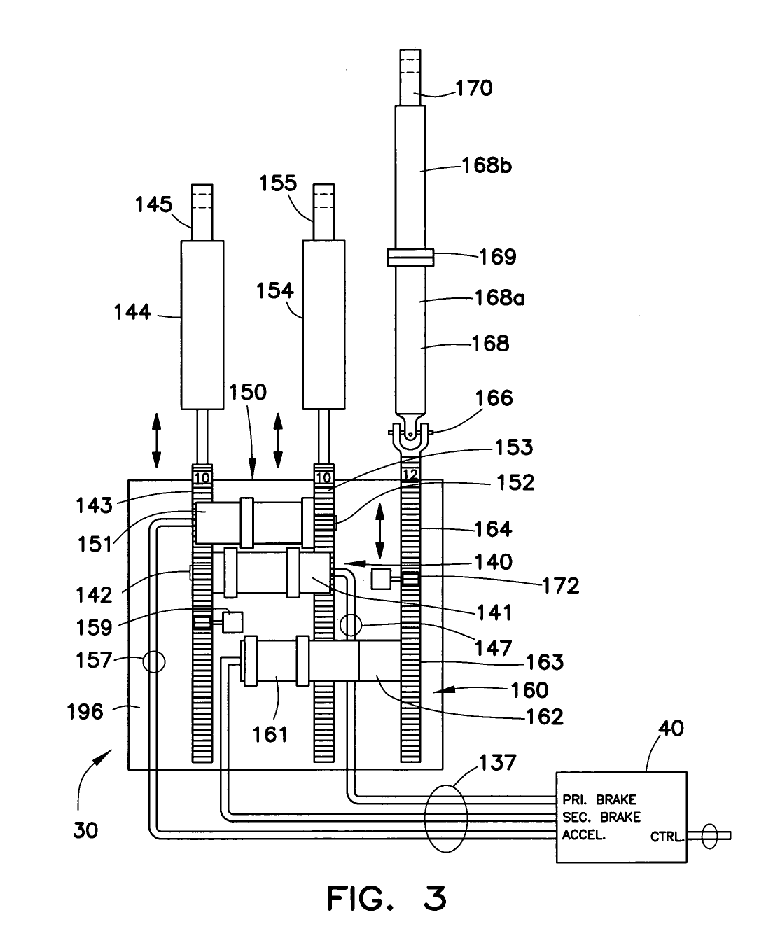

Turning to FIG. 3, the details of the actuator mechanism 30 can be seen. In the preferred embodiment, the brake pedal B and accelerator pedal A are controlled by way of electric motors. Thus, the motor control circuitry 40, which is preferably a microprocessor, transmits various control signals through motor control wires 137 fed to the actuator system 138. In the preferred embodiment, the brake pedal B is controlled by a primary brake assembly 140 and a secondary brake assembly 150. The two assemblies provide a fail-safe redundancy in the event of failure of one of the two brake assemblies. Each assembly 140, 150 includes a corresponding motor 141, 151, drive spindle 142, 152 and rack gear 143, 153. Each rack gear is connected to a drive link 144, 154, each of which terminates in a drive tab 145, 155.

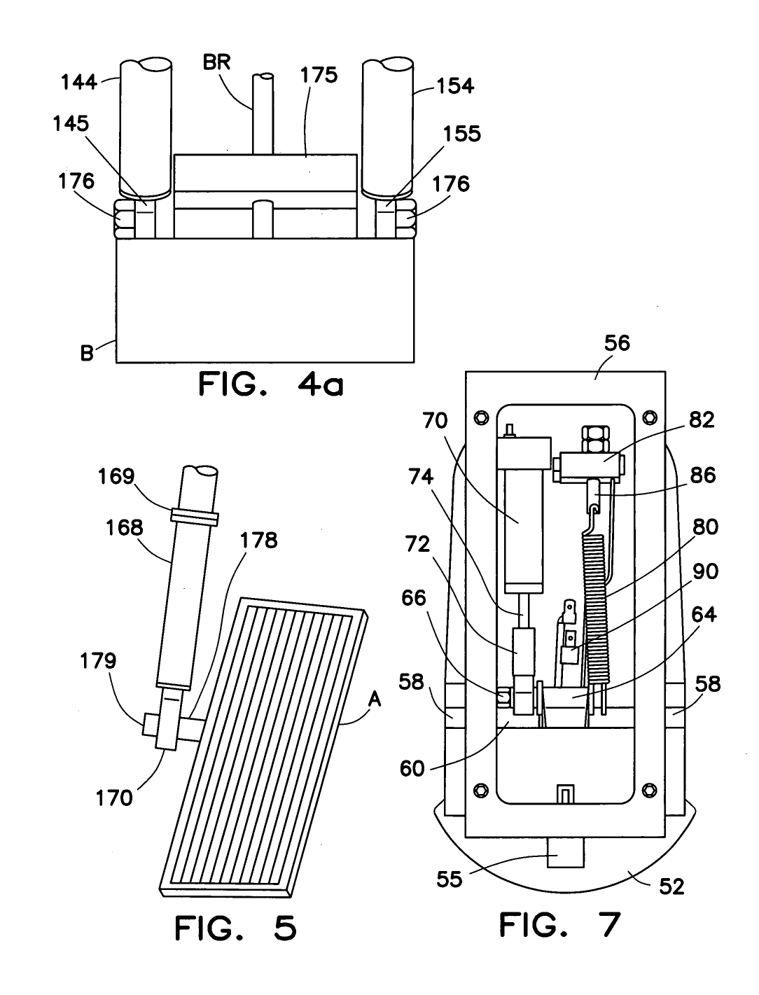

The drive links 144, 154 interface with the brake pedal B through the brake pedal arm BR as shown in FIG. 4a. More specifically, a linking bracket 175 is fixed to the brake pedal arm BR. Attachment bolts 176 mate with the drive tabs 145, 155 to fix the drive links 144, 154 to the linking bracket 175. Preferably, the drive pins 145, 155 permit some degree of pivoting of the drive links 144, 154 relative to the linking bracket 175. However, the drive link 144, 154 must be solidly connected to the linking bracket 175 along the longitudinal axis of the links so that translation of the links directly and instantly cause a corresponding downward movement of the brake pedal B by operation of the force on the brake pedal arm BR. It should be readily apparent that immediate and accurate movement of the brake pedal B is essential to the safety of the vehicle driver. Thus, the redundant primary and secondary brake assemblies 140, 150 help ensure that the failure of any single brake assembly will not compromise the braking function of the vehicle.

An alternative connection between the brake assemblies 140, 150 is depicted in FIG. 4b. This connection apparatus 185 includes a pair of clamping plates 187 that are sized to sandwich the brake pedal arm BR, as shown in the figure. A nut and bolt array 189 pass through corresponding holes in the clamping plates 187 and are tightened to firmly fix the plates to the brake pedal arm. The clamping plates include offsets 191 that provide a mating interface for a bearing end 194. Each bearing end 194 is held to the offsets and clamping plates by bolts 196.

In this embodiment, the bearing ends 194 are connected to the brake actuator links 144, 154 in a known manner. In a specific embodiment, a threaded engagement is provided between the components, in the manner of a typical rod end bearing, such as a Heim bearing. Most preferably, the bearing end 194 is configured like a Heim bearing so that the links 144, 154 can move or swivel relative to the clamping plates 187. This feature of the connection apparatus 185 provides a universal connection capability to virtually any form of brake pedal B and brake pedal arm BR, and ensures a proper line of action to the primary and secondary brake actuators 32, 34.

The present invention further contemplates a unique manner for supporting the actuator mechanism 30 to insure that the driving force generated by the primary and secondary brake assemblies is always perpendicular to the brake pedal arm BR, even as the arm BR is itself pivoted as the brake pedal B is depressed. This beneficial feature is accomplished through the mount 28 that is utilized to mount the actuator mechanism 30. More specifically, the mount 28 is adapted to engage the vehicle steering column underneath the dashboard D as shown in FIG. 2. This mount is in the form of a hinge to permit pivoting of the actuator mechanism 30 relative to the vehicle as the brake pedal B is depressed.

Returning to FIG. 3, the actuator system 138 also includes an accelerator actuator assembly 160. The actuator assembly includes a drive motor 161 that rotates a drive spindle 163, preferably through a transmission, such as planetary gearing, to step down the motor speed to an appropriate speed for the rest of the accelerator actuator system 138. Preferably, the actuator assembly includes a clutch 162 between the motor/transmission and the spindle. In a preferred embodiment, the clutch is an electromagnetic clutch that is activated by a signal from the control circuitry 135 through one of the control wires 137. The clutch 162 can be a free-wheeling clutch when no electrical current is provided to the clutch. When power is applied to the drive motor 161 and clutch 162, the clutch engages so that rotation of the motor leads to direct rotation of the drive spindle 163.

As with the primary and secondary brake assemblies, the accelerator assembly includes a rack gear 164 that is a meshed engagement with the drive spindle 163. The rack gear 164 terminates in a U-joint 166 that mounts to the drive link 168. Thus, the U-joint 166 permits multiple degrees of freedom of movement to account for actuation of the accelerator assembly. In addition, this U-joint allows the accelerator pedal actuator to accommodate the pivoting of the actuator housing 192 that occurs when the brake pedal is depressed, as described above. With this configuration, the independence between the brake actuators and the accelerator actuator can be maintained while the overall size of the actuator system 138 can be kept to a minimum.

Preferably, the link 168 includes a link adjustment feature 169 that permits fine adjustment of the length of the accelerator drive link 168 upon installation, namely by adjusting the relative position of the link halves 168a, 168b. The drive end of the link 168 forms a clevis 170 that can engage the accelerator pedal A linkage by way of a link bracket at 178 and bolt 179, as shown in FIG. 5. The clevis end 170 of the link accommodates pivoting of the link relative to the link bracket 178 as the drive link 168 is extended to depress the accelerator pedal A.

In the preferred embodiment, the free-wheeling clutch 162 essentially disconnects the drive link 168 from the motor 161 when power is shut off to the motor and clutch. In other words, when no acceleration command is issued or when a braking command is issued, then the accelerator drive link 168 is free to translate back and forth. With this arrangement, the return spring of the accelerator pedal is all that is necessary to push the drive link 168 back toward the actuator mechanism 30, restoring the rack gear 164 to its neutral position.

On the other hand, the primary and secondary brake assemblies do not permit a free-wheeling movement. In other words, the brake motors 141, 151 do not incorporate a clutch between the motor and the drive spindle 142. When power is terminated to either of the motors, the motors are held in whatever position they hold at the time power is terminated, which means that the rack gear 143, 153 are also held in their particular position. Ultimately, if the drive motors are fixed in position, then the drive links 144. 154 are fixed in position, which means that if the brake pedal B was depressed when the power to the brake assembly motors is terminated, then the brake will be maintained depressed. This is an important fail safe feature that permits release of the brake should electrical power to the actuator system 138 be interrupted for any reason.

When a braking maneuver is completed, the primary and secondary brake motors 141, 151 are reversed by the motor control circuitry 135. The motors are then reversed and the drive racks 143, 153 are retracted to release the brake pedal B. In one embodiment of the invention, proximity sensors or limit switches can be used to sense when the drive racks are at the limits of their stroke. In other words, when the brake motors 141, 151 are driven in reverse, a limit switch can be tripped by movement of the drive racks 143, 153 to prompt the motor control circuitry 135 to issue a motor stop command. Likewise, limit switches positioned at the limit of forward movement of the drive racks, corresponding to completely depressing the brake pedal B, can send a signal to the motor control circuitry to issue a motor stop command.

In one feature of the invention, the drive components of the actuator system 138 are mounted on a common support plate 196 that forms part of the actuator housing 192. Thus, the primary and secondary brake motors 141, 151 and the accelerator motor 161 are mounted on this support plate. Moreover, the rack gears 143, 153 and 164 are slidably supported on the plate 196. This common support characteristic reduces the size of the envelop occupied by the actuator system 138 and minimizes the incursion into the driver's space behind the steering wheel S.

In specific embodiments of the invention, the motors in the actuator system 138 are precision DC motors. The accelerator motor 161 can be a 90 watt, 15V motor, with a no load speed of 7070 rpm and a maximum continuous torque of 77.7 mNm. Preferably, the accelerator motor is geared down at a ratio of 74:1 to rotate the drive spindle 163. In the specific embodiments, the primary brake motor 141 can be a 150 watt, 12V motor with a no load speed of 6920 rpm and a maximum continuous torque of 98.7 mNm. The primary brake motor can be geared down at a ratio of 156:1 to rotate the spindle 142. The secondary brake motor 151 can be similar to the primary motor.

This assembly as thus far described can be configured as disclosed in concurrently filed utility patent application Ser. No. 10/632,543, filed on Aug. 1, 2003, in the name of the present inventor and entitled Joystick-Operated Driving System, the disclosure of which is incorporated herein by reference. Most particularly, the discussion of the control assembly at pages 20-26 and FIGS. 12-14, are specifically incorporated herein. In this co-pending application, the actuator system is controlled by a manually operated joystick. This joystick is configured to generate an acceleration command when moved in one direction and a braking command when moved in an opposite direction. The joystick of this co-pending disclosure is provided for a driver who lacks the effective use of his/her legs.

On the other hand, the present invention contemplates a control system 20 that accommodates a driver who is capable of generating foot pressure on an automotive pedal, but who is physically challenged in some respect so that the stock vehicle accelerator and brake pedals cannot be used. For instance, the driver may be unable to reach the vehicle pedals while maintaining a safe position within the vehicle. In other cases, the driver may not be able to generate sufficient pressure to displace the conventional vehicle pedals, especially the brake pedal. Thus, the present invention contemplates a foot controller 50 that forms part of the vehicle control system 20. This controller is intended to simulate the operation of a typical automotive accelerator or brake pedal, while account for the physical limitations of the driver.

As shown in FIG. 6, the foot controller 50 includes a pedal 52 in the form of a surface on which the driver rests his/her foot. The pedal can include a contoured backing plate 54 against which the driver's heel can rest for comfort and to help the driver apply leverage when depressing the pedal 52. The pedal is pivotably mounted to a housing 56 by pivot arms 58. A stop element 55 is provided between the pedal 52 and the housing 56 to stop the pedal is at its full retracted position. In the preferred embodiment, the stop element 55 is mounted to the housing 56, although it could also be mounted to the back end of the pedal itself.

The housing 56 is configured to elevate the pedal 52 above the existing vehicle pedals. The housing includes a plurality of mounting holes 57 through which bolts or screws pass to mount the housing 56 on the floor of the vehicle between the driver's seat and the vehicle pedals. Preferably the housing is located in a position that can be easily accessed by the physically challenged driver, but that is also free of the existing vehicle pedals to permit a non-impaired driver to operate the vehicle pedals. The height of the housing 56 is determined by the physical needs of the impaired driver, although the height will typically fall within the range of 6-12 inches.

The depth of the housing 56 and foot pedal 52 is sized to accept the driver's foot without extending to far toward the existing vehicle pedals. The fore-aft depth of the housing and foot pedal will typically be about 12 inches.

As shown in FIG. 7, the pivot arms 58 straddle the housing 56 so the pedal is stably supported. An axle 60 extends through holes (not shown) in the housing 56 and mates with the pivot arms 58 on the opposite sides of the housing. Thus, the axle 60 pivots as the pivot arms are rotated, and the arms 58 are rotated as the pedal 52 is depressed toward the housing.

The interior of the housing 56 is exposed in FIG. 7 showing the internal components of the foot controller 50. The axle 60 includes a fulcrum plate 64 attached thereto so that the plate 64 pivots are the axle rotates. The fulcrum plate 64 is shown in its neutral position in FIG. 7 in which the pedal is not depressed but is instead upright, as shown in FIG. 6. As the pedal is depressed, the pivot arms 58 rotate the axle 60 which pivots the fulcrum plate 64 toward the bottom of the figure.

The free end of the fulcrum plate 64 includes a pivot pin 66 extending therethrough. The pin is exposed on opposite sides of the plate 64 so that it can be engaged to the internal components of the foot controller 50. In particular, the pin engages the clevis link 72 of a position sensor 70. The sensor 70 includes a rod 72 that extends therefrom and carries the clevis link 72. As the fulcrum plate 64 pivots away from the sensor, it pulls the rod 72 with it. The direction and magnitude of movement of the rod is evaluated by the sensor 70 which generates a commensurate electrical signal. In a specific embodiment, the sensor 70 is a potentiometer that produces a voltage signal whose magnitude is a function of the movement of the rod 72 away from its neutral position. This signal is fed to the microprocessor in the form of a position command. When the foot controller 50 is used as an accelerator, this signal is indicative of an acceleration command. The controller 50 can also be used as a brake pedal, so the sensor signal will constitute a braking command. In either case, the magnitude of the sensor signal is a function of the amount that the pedal 52 is depressed, which is a reflection of the driver's desired acceleration or braking.

The opposite end of the pin 66 is connected to a return spring 80. One end of the return spring is engaged to the pin, while the opposite end is engaged to a stationary mount 82. In one embodiment, the spring is an extension spring that is fixed at its ends to the pin 66 and mount 82. However, in the preferred embodiment, the spring 80 is engaged to the mount 82 to permit adjustment of the spring force exerted by the extension spring 80 against the pivoting movement of the fulcrum plate 64. This adjustment capability is accomplished by an adjustment screw 86 that is threaded through a bore (not shown) in the mount 82. The end of the screw 86 is fastened to the end of the spring 80. The spring force can be adjusted by backing the adjustment screw 86 out of the mount 82, thereby stretching the extension spring 80.

The foot controller 50 can also include a limit switch assembly 90 that is activated when the foot pedal is at one limit of its movement—either fully depressed, or “pegged”, or neutral, or un-depressed. The purpose of the limit switch assembly depends upon the use for the particular foot controller 50. As indicated above, both the acceleration and braking function can be delegated to its own foot controller. Where the controller operates as an accelerator, the limit switch assembly can be used to activate or deactivate the clutch 162 of the acceleration control mechanism 160. If the controller 50 is used as a brake pedal, the limit switch can be used to activate an emergency braking protocol.

The limit switch assembly 90 can include a conventional limit switch that incorporates a cam-follower approach. With this approach, the limit switch can include the follower, while the axle 60 can include a cam surface. For use of the foot controller as an accelerator, the axle can include a cam surface at the neutral position of the pedal (as shown in FIG. 6), since this position corresponds to a “no acceleration” command. The cam surface can cause the limit switch to change state between open and closed, which generates a signal read by the microprocessor 40 to activate or deactivate the clutch 162 accordingly.

On the other hand, when the foot controller 50is used as a brake, the limit condition occurs when the pedal is fully depressed, such as for an emergency braking maneuver. In this instance, the axle 60 can again include an appropriately positioned cam surface that bears on the cam follower of the limit switch when the axle is rotated to its limit. The change of state of the limit switch 90 can send a signal to a four wheel electrical braking system to activate the system for emergency stopping power.

It is understood that two foot controllers 50 can be provided in a given vehicle to allow left and right foot operation by the driver. The present invention allows the foot controller to be mounted anywhere in the driver compartment for easy access by the physically challenged driver. It is also understood that these foot controllers do not replace the existing vehicle accelerator and brake pedals. To the contrary, the control system 20 relies upon the existing pedals to perform the acceleration and braking functions, since the foot controllers 50 provide control signals to the microprocessor, which then provides appropriate signals to the motors of the actuator mechanism 30 to depress the existing vehicle pedals.

The stroke of the pedal 52 of the foot controller can correspond to the stroke of the vehicle pedals. Optimally, however, the stroke of the controller 50 pedal 52 is calibrated to the physical needs of the driver. For instance, if the driver is not able to produce minute controlled movements of the foot, the foot pedal, and particularly the microprocessor, can be calibrated so that gross movement of the pedal 52 is scaled down accordingly. Similarly, the driver may have different levels of functionality of either foot, which can translate into differential settings for the two foot controllers 50.

In another aspect of the invention, the on-board controller, or microprocessor 40 is programmed to prevent conflicting acceleration and braking signals. With the use of separate foot controllers for each foot of the driver, there is some risk that the driver will depress both pedals in an emergency condition. When the microprocessor receives both an acceleration and a braking command, it ignores the acceleration command in favor of stopping the vehicle. The microprocessor can be programmed to ignore the acceleration only when an emergency braking command has been issue, such as by fully depressing the pedal of the braking foot controller. Where the braking command is minimal, the microprocessor can override the braking command and process only the acceleration command, on the theory that the driver is simply “riding the brake”.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A system for use by a physically impaired driver for controlling a pedal of a motor vehicle, comprising:
a foot pedal mounted within the vehicle offset from the pedal of the vehicle, said foot pedal movable by the driver's foot away from a neutral position corresponding to depressing the vehicle pedal, said foot pedal including a return mechanism for restoring said foot pedal to said neutral position;
an actuator assembly operably coupled to the vehicle pedal to depress the vehicle pedal when activated; and
an electrical control system connected between said foot pedal and said actuator assembly and operable to activate said actuator to depress the vehicle pedal when said foot pedal is moved away from said neutral position.

2. The system of claim 1, wherein said foot pedal is supported on a housing configured to elevate said foot pedal above the vehicle pedal.

3. The system of claim 2, wherein said foot pedal is pivotably mounted on said housing.

4. The system of claim 3, wherein said electrical control system includes:
a sensor coupled to said foot pedal and operable to generate a signal whose magnitude is a function of the amount of movement of said foot pedal away from said neutral position; and
an electrical controller having a motor for driving said actuator assembly in response to said magnitude of said signal.

5. The system of claim 4, wherein said electrical control system further includes:
a limit switch operably coupled to said foot pedal to generate a limit signal when said foot pedal has been moved to a limit position relative away from said neutral position; and
said electrical controller is operable to control said motor independent of said magnitude of said signal when said limit signal is received by said controller.

6. The system of claim 2, wherein said return mechanism includes a spring coupled between said housing and said foot pedal.

7. The system of claim 6, wherein said spring is an extension spring operable to resist movement of said foot pedal away from said neutral position.

8. The system of claim 7, wherein the resistance of said extension spring is adjustable.
